(19) United States
(12) Patent Application Publication
(10) Pub. No.: US 2010/0073783 A1
(43) Pub. Date: Mar. 25, 2010

(54) FOCUS-ADJUSTABLE OPTICAL ASSEMBLY

(75) Inventor: TSUNG-TING SUN, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: EDISON OPTO CORPORATION, TAIPEI HSIEN (TW)

(21) Appl. No.: 12/235,863

(22) Filed: Sep. 23, 2008

(51) Int. Cl. G02B 7/04; F21S 8/00

(52) U.S. Cl. 359/822; 362/268

(57) ABSTRACT

A focus-adjustable optical assembly installed in at least one projecting path of at least one light beam is disclosed in the present invention. The focus-adjustable optical assembly comprises a lens fixing disk and a plurality of lenses. The lens fixing disk is made of a light-transmissible material, and formed with a plurality of lens assembling passages. The lenses are rotatably and threadedly assembled to the lens assembling passages along at least one focus-adjustment direction. At least one focusing position of the light beam is adjusted when rotatably adjusting at least one of the lenses with respect to the lens assembling passages.

### FIELD OF THE INVENTION

The present invention relates to an optical assembly, and more particularly to an optical assembly with a plurality of lenses capable of being rotatably adjusted to adjust at least one focusing position of at least one light beam.

### BACKGROUND OF THE INVENTION

In the daily life, for modulating light beams with diversified optical properties, it is usually necessary to install optical components to adjust the optical properties of the light beams. Among these optical components, the lenses are the most representative. Generally speaking, the existed lenses mainly include convex lenses for concentrating light beams, and concave lenses for diverging light beams.

In the conventional technologies, at least one optical assembly is installed in projecting paths of light beams respectively projected from light sources when it is necessary to adjust the optical properties of the light beams. More often, the optical assembly includes a plurality lenses with respect to the light beams, so as to respectively adjust the optical properties of the light beams.

For further presenting the prior arts as mentioned above, following up, more detailed description and figures will be provided to illustrate the most representative optical assembly in accordance with the prior arts. Please refer to FIG. 1 and FIG. 2, wherein FIG. 1 illustrates that a conventional optical assembly is installed in the paths of a plurality of light beams respectively projected from a plurality of light beams; and FIG. 2 is a cross-sectional view of FIG. 1 along an A-A direction, so as to illustrate that the light beams projected from the light sources are respectively concentrated in focusing positions after projecting to the optical assembly. As presented in the figures, an illumination assembly 1 comprises a circuit board 11 and three light sources 12, 13 and 14. The light sources 12, 13 and 14 are mounted on the circuit board 11, and respectively project three light beams LB1, LB2 and LB3 along a projecting direction I. In other words, the projecting paths of the light beams LB1, LB2 and LB3 are extended along the projecting direction I.

An optical assembly 2 comprises a light-transmissible disk body 21 and three fixed type lenses 22, 23 and 24 formed in an integral part with the light-transmissible disk body 21. The fixed type lenses 22, 23 and 24 are respectively located in the projecting paths of the light beams LB1, LB2 and LB3, and kept in a projecting distance d from the light sources 12, 13 and 14. Moreover, the light beams LB1, LB2 and LB3 are respectively concentrated in three focusing positions P1, P2 and P3 after projecting to the fixed type lenses 22, 23 and 24.

Any person skilled in the ordinary art can easily realize that, in the prior arts cited above, it is unable to individually adjust the projecting distance d between the lens 22 and the light source 12, the lens 23 and the light source 13, or the lens 24 and the light source 14. Obviously, in the prior art, it is unable to individually adjust the focusing position P1, P2 or P3, so that it is unable to modulate more diversified concentrated light beams. Hence, the inventor of the present invention is of the opinion that it is necessary to develop a new optical assembly, which is expected to modulate more diversified concentrated light beams.

### SUMMARY OF THE INVENTION

Due to that the optical assembly of prior art exists the problem of being unable to modulate more diversified concentrated light beams, the primary objective of the present invention provides a focus-adjustable optical assembly comprising a lens fixing disk and a plurality of lenses rotatably assembled to lens fixing disk, so as to rotatably and individually adjust the projecting distance between the any one of the lenses and the respected one of the light sources.

Means of the present invention for solving the problems as mentioned above provides a focus-adjustable optical assembly. The focus-adjustable optical assembly is installed in at least one projecting path of at least one light beam projected from at least one light source, and comprises a lens fixing disk and a plurality of lenses. The lens fixing disk is made of a light-transmissible material, and formed with a plurality of lens assembling passages. The lenses are rotatably and threadedly assembled to the lens assembling passages along at least one focus-adjustment direction. When any one of the lenses is rotatably adjusted with respect to the lens assembling passages, the projecting distance is adjusted, so as to adjust the focusing position(s) of the light beam(s).

In one preferred embodiment of the present invention, a fixing disk is formed with a plurality of assembling passages, a plurality of said focus-adjustable optical assemblies can be further assembled to the assembling passages to make an integrated optical assembly for providing more diversified functions of light-concentration.

Comparing with the conventional optical assembly as disclosed in prior arts, in the present invention, the projecting distance(s) and the focusing position(s) of the light beam(s) can be adjusted by rotating at least one lens with respect to the lens assembling passage(s). Therefore, it is able to modulate more diversified concentrated light beam(s) by rotating at least one of the lenses.

The devices, characteristics, and the preferred embodiment of this invention are described with relative figures as follows.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 illustrates that a conventional optical assembly is installed in the paths of a plurality of light beams respectively projected from a plurality of light beams;

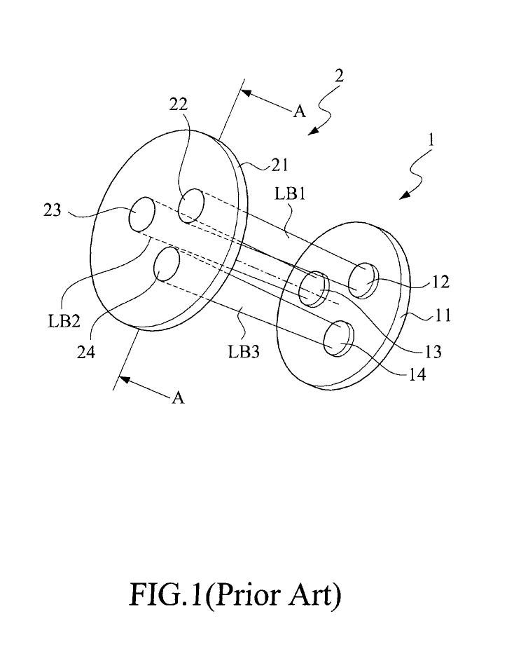

FIG. 2 is a cross-sectional view of FIG. 1 along an A-A direction, so as to illustrate that the light beams projected from the light sources are respectively concentrated in focusing positions after projecting to the optical assembly;

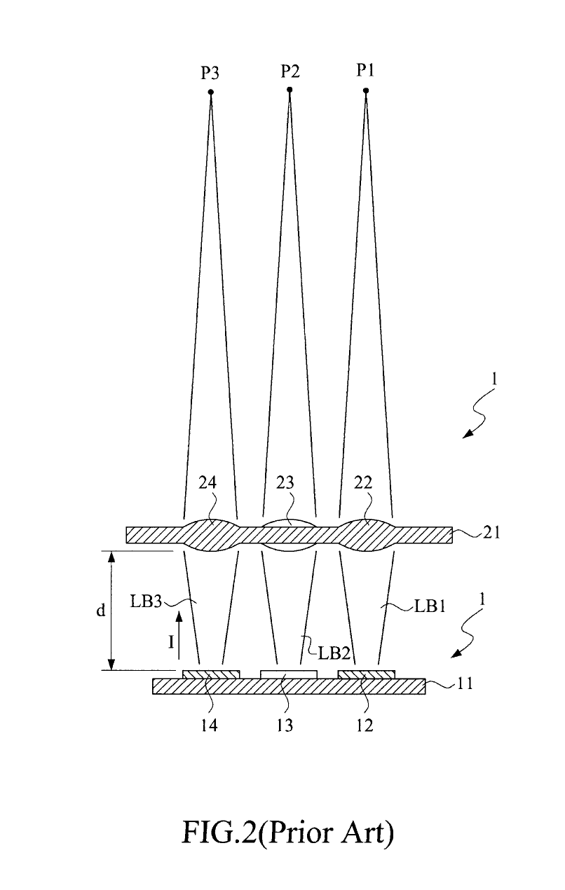

FIG. 3 illustrates that a focus-adjustable optical assembly is installed in the paths of a plurality of light beams respectively projected from a plurality of light beams in accordance with a first embodiment of the present invention;

FIG. 4 is a cross-sectional view of FIG. 3 along a B-B direction, so as to illustrate that the light beams projected from the light sources are respectively concentrated in focusing positions after projecting to the focus-adjustable optical assembly;

FIG. 5 illustrates that in the first embodiment of the present invention, the projecting distances of the light beams can be adjusted after rotatably adjusting the lenses with respect to the lens assembling passages;

FIG. 6 illustrates that in the first embodiment of the present invention, the focusing positions of the light beams can be adjusted after rotatably adjusting the lenses with respect to the lens assembling passages;

FIG. 7 illustrates that in a second embodiment of the present invention, one lens is rotatably and threadedly assembled to the lens assembling passage along another focus-adjustment direction non-parallel to the projecting path of the light beam;

FIG. 8 illustrates the light-concentration functions of different kinds of lenses in accordance with the third embodiment of the present invention; and

FIG. 9 illustrates that a plurality of optical assemblies are rotatably and threadedly assembled to a fixing disk to make an integrated optical assembly in accordance with a fourth embodiment of the present invention.

### DETAILED DESCRIPTION OF THE PREFERRED EMBODIMENTS

The focus-adjustable optical assembly as provided in accordance with the present invention is to rotatably and threadedly assemble the lenses to the lens assembling passages, so that it is able to adjust the projecting distance(s) and the focusing position(s) of the light beam(s) by rotating at least one of the lenses with respect to the lens assembling passage(s). Therefore, the present invention can be widely applied to many kinds of optical uses. Obviously, the combined applications of the present invention are too numerous to be enumerated and described, so that only four preferred embodiments are disclosed as follows for representation.

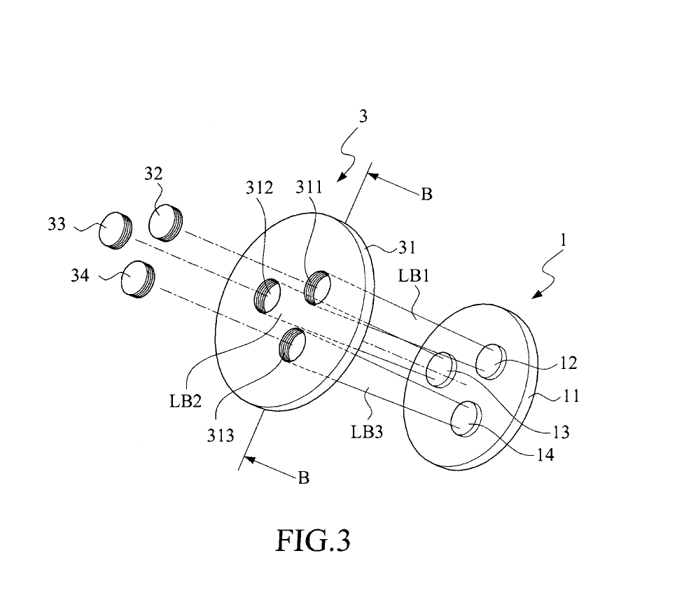

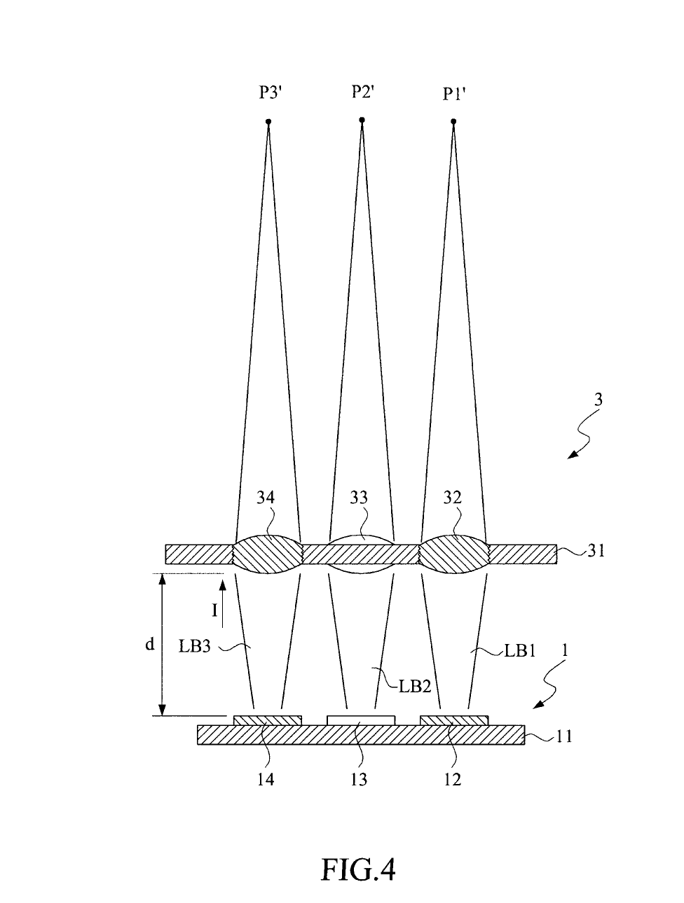

Please refer to FIG. 3 and FIG. 4, wherein FIG. 3 illustrates that a focus-adjustable optical assembly is installed in the paths of a plurality of light beams respectively projected from a plurality of light sources in accordance with a first embodiment of the present invention; and FIG. 4 is a cross-sectional view of FIG. 3 along a B-B direction, so as to illustrate that the light beams projected from the light sources are respectively concentrated in focusing positions after projecting to the focus-adjustable optical assembly. As presented in the figures, a focus-adjustable optical assembly (being simplified by “optical assembly” hereinafter) 3 is applied to provide the light-concentration functions for the illumination assembly 1 as mentioned in prior arts, and comprises a lens fixing disk 31 and three lenses 32, 33 and 34.

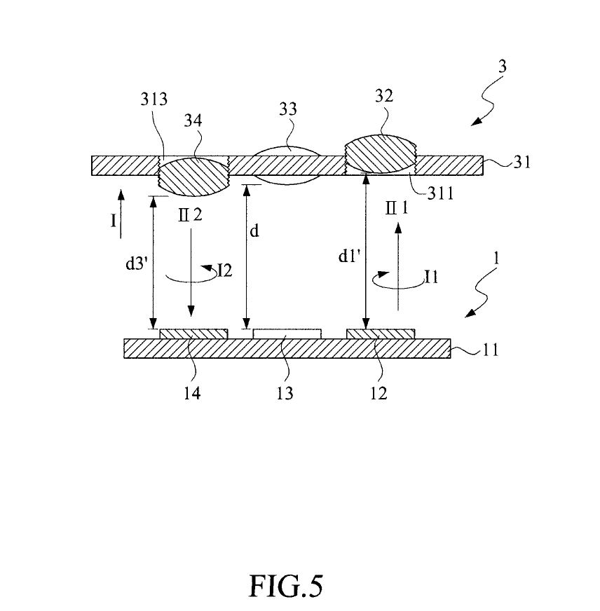

The lens fixing disk 31 is made of a light-transmissible material and formed with three lens assembling passages 311, 312 and 313 respectively having a threaded inner wall. The lenses 32, 33 and 34 are respectively installed in the projection paths of the light beams LB1, LB2 and LB3, and each of the lenses 32, 33 and 34 has a threaded outer wall. Through the threaded inner walls matching with the threaded outer walls, the lenses 32, 33 and 34 can be rotatably and threadedly assembled to the lens assembling passages 311, 312 and 313 respectively along a focus-adjustment direction ∥ 1 or ∥ 2 (shown in FIG. 5).

Under an initial state, the lenses 32, 33 and 34 are respectively kept in a projecting distance d from the light sources 12, 13 and 14. Moreover, in the first embodiment of the present invention, the lenses 32, 33 and 34 are convexo-convex lenses; therefore, the light beams LB1, LB2 and LB3 are respectively transmitted through the lenses 32, 33 and 34, and concentrated in three focusing positions P1′, P2′ and P3′ after projecting to the lenses 32, 33 and 34.

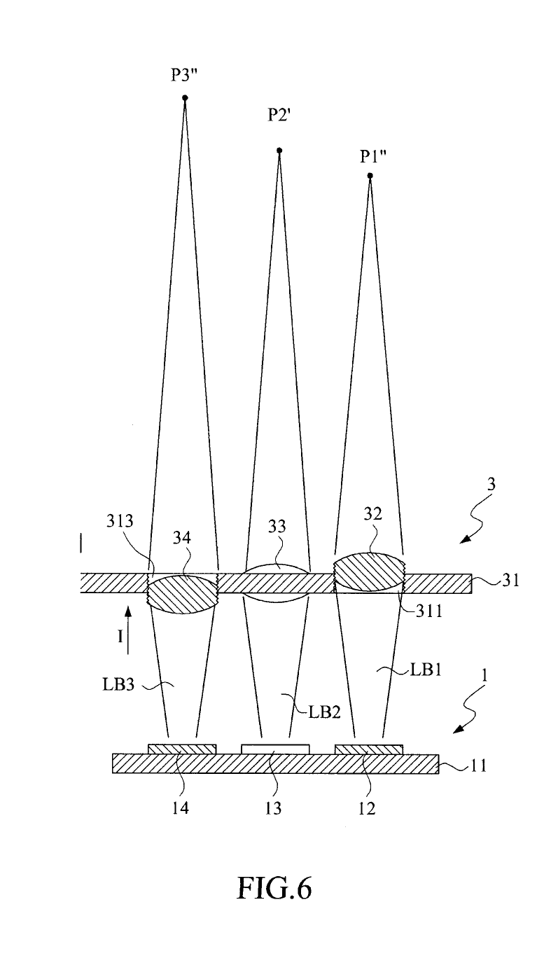

Please refer to FIG. 5 and FIG. 6, wherein FIG. 5 illustrates that in the first embodiment of the present invention, the projecting distances of the light beams can be adjusted after rotatably adjusting the lenses with respect to the lens assembling passages; and FIG. 6 illustrates that in the first embodiment of the present invention, the focusing positions of the light beams can be adjusted after rotatably adjusting the lenses with respect to the lens assembling passages. As shown in the figures, when a user rotates the lens 32 along a rotation direction I1 to make the lens 32 move along the focus-adjustment direction ∥ 1, the original projecting distance d is adjusted to be another projecting distance d1′, so as to make the light beam LB1 be concentrated in another focusing position P1″.

Similarly, when the user rotates the lens 34 along a rotation direction I2 to make the lens 34 move along the focus-adjustment direction ∥ 2, the original projecting distance d is adjusted to be another projecting distance d3′, so as to make the light beam LB3 be concentrated in another focusing position P3″.

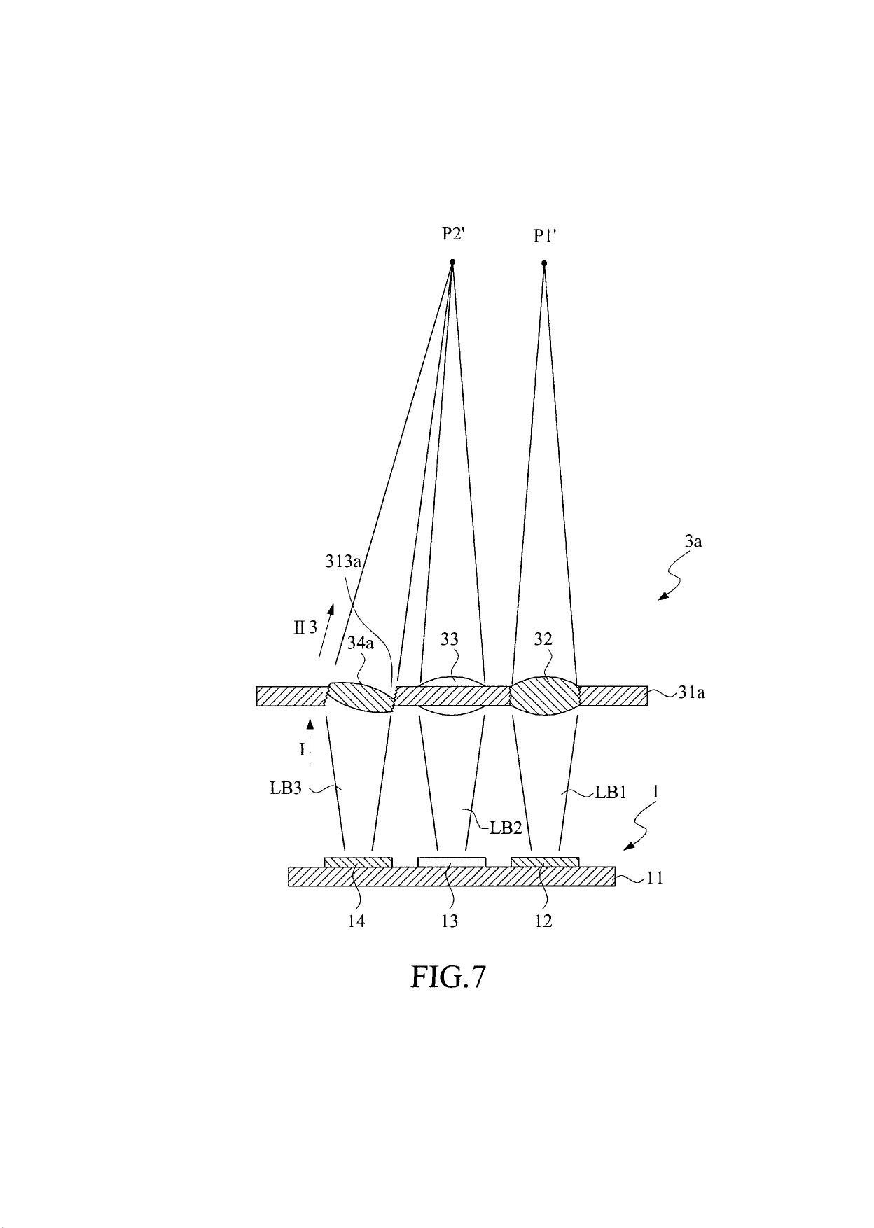

Please refer to FIG. 7, which illustrates that in a second embodiment of the present invention, one lens is rotatably and threadedly assembled to the lens assembling passage along another focus-adjustment direction non-parallel to the projecting path of the light beam. As presented in FIG. 7, in the second embodiment of the present invention, another optical assembly 3a is applied to replace the optical assembly 3 of the first embodiment of the present invention. In the optical assembly 3a, another lens fixing disk 31a and another lens 34a are applied to replace the lens fixing disk 31 and the lens 34 as mentioned in the first embodiment of the present invention.

In the lens fixing disk 31a, another lens assembling passing 313a is formed along another focus-adjustment direction ∥ 3 non-parallel to the projecting direction I of the light beam LB3, so as to replace the lens assembling passing 313 of the first embodiment of the present invention. In other words, in the second embodiment of the present invention, the focus-adjustment direction ∥ 3 is non-parallel to the projecting path of the light beam LB3. From FIG. 7, it is obvious that the light beam LB3 also can be concentrated in the focusing position P2′ after projecting to the lens 34a.

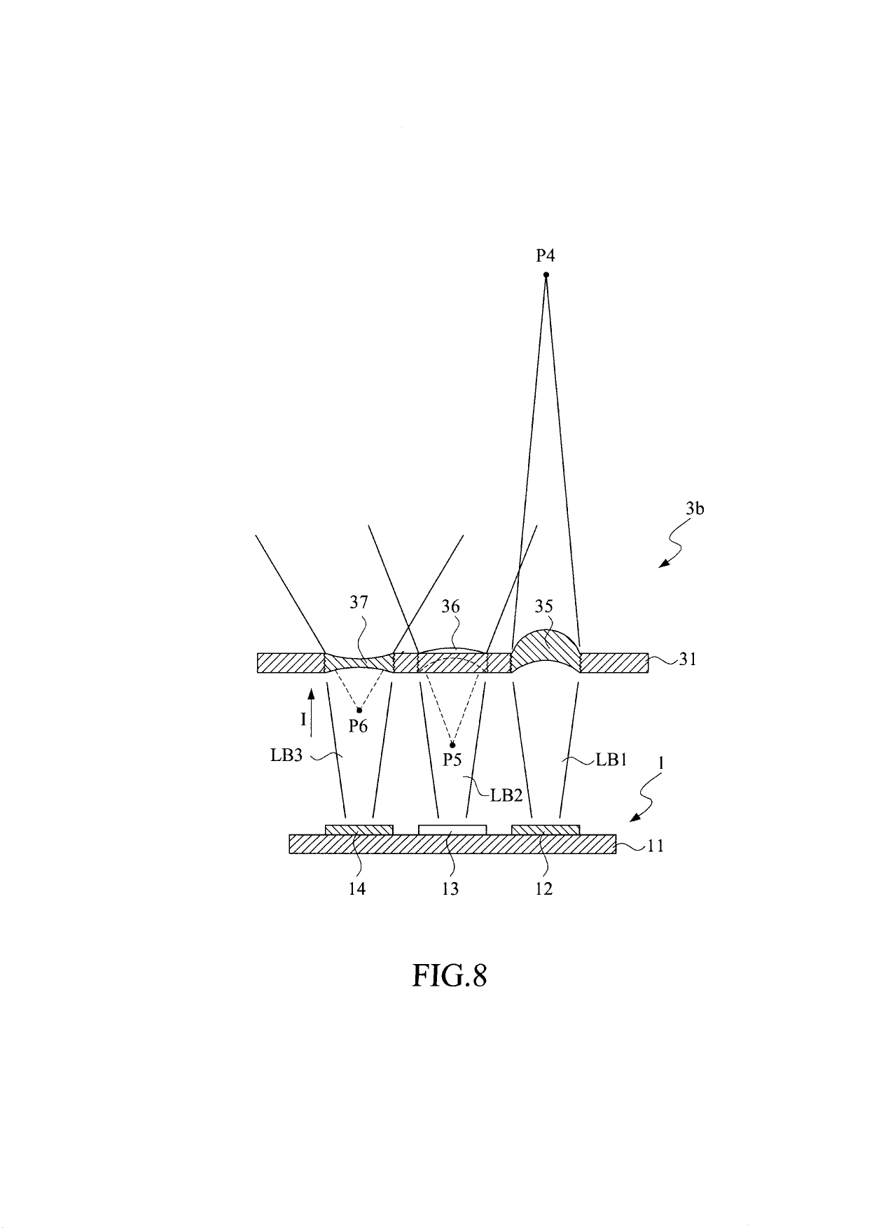

In the first embodiment and the second embodiment, all lenses applied to make the optical assemblies are convexo-convex lenses. In a third embodiment of the present invention, the light-concentration functions of another three kinds of the lenses are further disclosed for reference. Please refer to FIG. 8, which illustrates the light-concentration functions of different kinds of lenses in accordance with the third embodiment of the present invention. As shown in FIG. 8, another three lenses 35, 36 and 37 are applied to replace the lenses 32, 33 and 34 as mentioned above, so as to make another optical assembly 3b.

The lens 35 is a concave-convex lens, so that the light beam LB1 is transmitted through the lens 35 and concentrated in a focusing position P4 after projecting to the lens 35. The lens 36 is a convex-concave lens, so that after the light beam LB2 is projected to the lens 36, a part of the light beam LB2 is diverged after transmitting through the lens 36, but a part of the light beam LB2 is reflected by the lens 36 and concentrated in a focusing position P5. The lens 37 is a concavo-concave lens, so that after the light beam LB3 is projected to the lens 37, a part of the light beam LB3 is diverged after transmitting through the lens 37, but a part of the light beam LB3 is reflected by the lens 37 and concentrated in a focusing position P6.

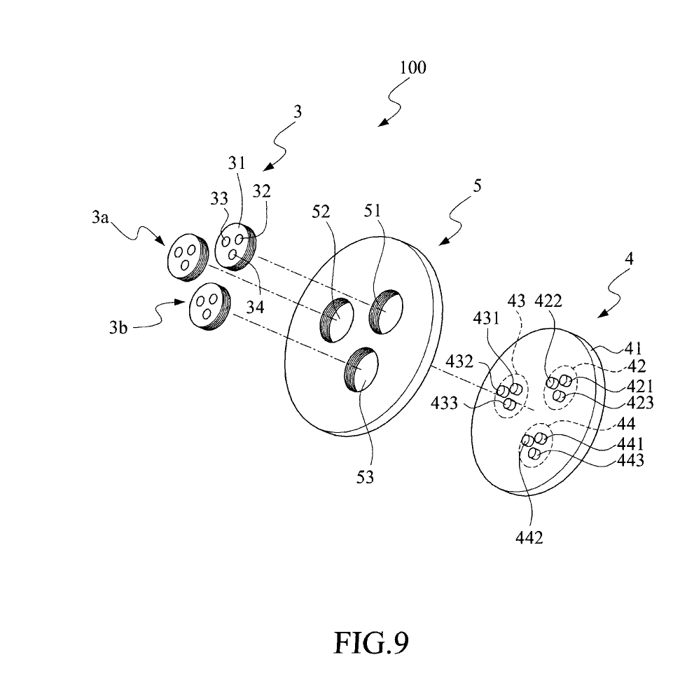

Please refer to FIG. 9, which illustrates that a plurality of optical assemblies are rotatably and threadedly assembled to a fixing disk to make an integrated optical assembly in accordance with a fourth embodiment of the present invention. As shown in FIG. 9, an illumination assembly 4 comprises a circuit board 41 and three light source groups 42, 43 and 44. The light source groups 42, 43 and 44 are respectively mounted on the circuit board 41. The light source group 42 comprises three light sources 421, 422 and 423; the light source group 43 comprises three light sources 431, 432 and 433; and the light source group 44 comprises three light sources 441, 442 and 443.

A fixing disk 5 is formed with three assembling passages 51, 52 and 53. The optical assemblies 3, 3a and 3b can be rotatably and threadedly assembled to the assembling passages 51, 52 and 53 to make an integrated optical assembly 100. The optical assembly 3 can be installed in the projecting paths of the light beams (not shown) projected from the light sources 421, 422 and 423; the optical assembly 3a can be installed in the projecting paths of the light beams (not shown) projected from the light sources 431, 432 and 433; and the optical assembly 3b can be installed in the projecting paths of the light beams (not shown) projected from the light sources 441, 442 and 443.

Any person skilled in ordinary arts can easily realize that any one of the light sources can be a light emitting diode (LED) light source. In the present invention, the lenses are rotatably and threadedly assembled to the lens assembling passages, and the optical assemblies are rotatably and threadedly assembled to the assembling passages; therefore, it is able to adjust the projecting distance(s) and the focusing position(s) by rotating at least one of the lenses or the optical assemblies. Furthermore, it is able to remove any one of the lenses or the optical assemblies, and select different kinds of lenses (e.g. the convexo-convex lens, the concave-convex lens, the concavo-concave lens, and convex-concave lens) to be assembled to the lens assembling passages, so as to make the light beam(s) have more diversified optical properties after projecting to the optical assembly or the integrated optical assembly. Making a summary according to above description, the present invention really can provide more diversified functions of light-concentration.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A focus-adjustable optical assembly, installed in at least one projecting path of at least one light beam, and comprising:
a lens fixing disk made of a light-transmissible material, and formed with a plurality of lens assembling passages; and
a plurality of lenses rotatably and threadedly assembled to the lens assembling passages along at least one focus-adjustment direction;
wherein at least one focusing position of the light beam is adjusted when rotatably adjusting at least one of the lenses with respect to the lens assembling passages.

2. The focus-adjustable optical assembly as claimed in claim 1, wherein the light beam is projected from at least one light source.

3. The focus-adjustable optical assembly as claimed in claim 2, wherein the light source is a light emitting diode (LED) light source.

4. The focus-adjustable optical assembly as claimed in claim 1, wherein at least one of the lenses is removable.

5. The focus-adjustable optical assembly as claimed in claim 1, wherein at least one of the lenses is a convexo-convex lens.

6. The focus-adjustable optical assembly as claimed in claim 1, wherein at least one of the lenses is a concavo-concave lens.

7. The focus-adjustable optical assembly as claimed in claim 1, wherein at least one of the lenses is a convex-concave lens.

8. The focus-adjustable optical assembly as claimed in claim 1, wherein at least one of the lenses is a concave-convex lens.

9. The focus-adjustable optical assembly as claimed in claim 1, wherein the projecting path is non-parallel to the focus-adjustment direction.

10. An integrated optical assembly comprising:
a fixing disk formed with a plurality of assembling passages; and
a plurality of the focus-adjustable optical assemblies as claimed in claim 1 rotatably and threadedly assembled to the assembling passages.
